(19) United States
(12) Patent Application Publication
(10) Pub. No.: US 2013/0029171 A1
(43) Pub. Date: Jan. 31, 2013

(54) Nickel-Base Alloy

(71) Applicants: Philip Johann Meinrad Speck, Munich (DE); David J. Young, Sydney (AU)

(72) Inventors: Philip Johann Meinrad Speck, Munich (DE); David J. Young, Sydney (AU)

(73) Assignee: Philip Johann Meinrad Speck, Munich (DE)

(21) Appl. No.: 13/552,923

(22) Filed: Jul. 19, 2012

(30) Foreign Application Priority Data
Jul. 25, 2011 (AU) 2011902957

(51) Int. Cl. B32B 1/08; C22C 19/05

(52) U.S. Cl. 428/596; 420/445; 420/443; 420/590

(57) ABSTRACT

A nickel-base alloy comprising: 12-40 wt % chromium; up to 13 wt % copper; up to 8% aluminium; balance nickel and incidental impurities is disclosed. Such alloys show an improved carbon corrosion resistance at high temperatures. Such an alloy could therefore be utilised in chemical processing or conveying apparatus, such as steam reforming, syngas production, fertilizer production, ammonia production or coal gasification, or more generally where gases with high carbon potentials are present. The alloy may further comprise one or more rare earth elements, up to a combined total of 1 wt %.

### CROSS-REFERENCE TO RELATED APPLICATIONS

The present application claims priority to Australian Provisional Patent Application No. 2011902957 filed on Jul. 25, 2011, the entire contents of which is incorporated herein for all purposes by this reference.

### TECHNICAL FIELD

A nickel-base alloy, a method for producing a nickel-base alloy and an article of manufacture having an improved carbon corrosion resistance, for example carburization, metal dusting or coking, are disclosed.

### BACKGROUND ART

Carbon corrosion resistance of traditional solid solutions of nickel and aluminium is not satisfactory. The intermetallic phases in the Ni-Al system show much better carburization resistance, however, the extreme hardness and brittleness and the resulting problems for forming and machining disqualify them as structural materials except for very special applications e.g. in turbine airfoils where cost considerations are only of secondary importance.

Gamma-phased nickel alloys and pure nickel have shown that low concentrations of oxide-forming alloy constituents exacerbate metal dusting corrosion, possibly through the fast inwards diffusion of carbon along internal oxides.

Alloys of copper and some other transition metals, e.g. silver, have shown good resistance to metal dusting corrosion. However, the lower melting temperature and high temperature creep and rupture strength of copper alloys, when compared with nickel alloys, limit the use of copper alloys in high temperature applications. Additional factors which have also limited the use of copper alloys are the low solubility of chromium and the limited solubility of aluminium in copper. This has limited the development of copper based alloys that are resistant to high temperature oxidation.

The above references to the background art do not constitute an admission that the art forms a part of the common general knowledge of a person of ordinary skill in the art. The above references are also not intended to limit the application of the alloy as disclosed herein.

### SUMMARY OF THE DISCLOSURE

According to a first aspect, there is disclosed a nickel-base alloy comprising: 12-40 wt % chromium; up to 13 wt % copper; up to 8% aluminium; balance nickel and incidental impurities.

An alloy with the above composition has been shown to have an improved carbon corrosion resistance at temperatures in the range of about 400-1000° C. Such an alloy may therefore be utilised in chemical processing or conveying apparatus, such as steam reforming, syngas production, fertilizer production, ammonia production or coal gasification, or more generally where gases with high carbon potentials are present.

When the alloy is exposed to high temperatures, both chromium and aluminium form a protective oxide scale on the surface of the alloy. The resultant scales, chromium oxide Cr₂O₃ and aluminium oxide Al₂O₃, protect the bulk of the alloy from exposure to, for example, corrosive gases. While aluminium oxide is generally more stable than chromium oxide, the solubility of chromium in nickel is substantially higher than aluminium. Therefore a balance between these two elements is employed.

Copper, on the other hand, suppresses the ability of the nickel-base alloy matrix to catalyse carbon release from, for example, a gas, thus reducing deposition of carbon on the alloy. This allows the alloy to resist carbon attack whilst the chromium and aluminium oxide scales form and reform after damage. Such damage to the oxide scales may be caused by temperature fluctuation which creates strain in oxide scales due to different thermal expansion co-efficients of the various scales, leading to spallation. After spallation of part of the oxide scales, without the presence of copper, the alloy would again be exposed to carbon attack whilst the scale is reforming.

The solubilities of copper and chromium in nickel are dependent on each other and thus compromise can be optimised between the protective oxide effect of chromium (and aluminium) and suppression of the catalytic carbon effect by copper.

In one embodiment, the nickel-base alloy may further comprise one or more rare earth elements, up to a combined total of 1 wt %. The rare earth element may, for example, be at least one of yttrium, hafnium, cerium, zirconium, scandium or lanthanum. The inclusion of at least one rare earth element improves the alloy's cyclic high temperature oxidation resistance. The inclusion of more than 1 wt % of rare earth elements will decrease the resistance to, for example, metal dusting. The combined wt % total of rare earth elements, in embodiments where the alloy includes rare earth elements, may be lower than 1 wt %. For example, the alloy may contain up to 0.5 wt %, 0.1 wt % or 0.01 wt % rare earth element(s).

In one embodiment, the alloy is a substantially single-phase solid solution alloy. A single-phase alloy provides superior carburisation, metal dusting and coking resistance as there are no phase boundaries in the alloy. Phase boundaries may act as an initiation site for e.g. dusting attack. However, secondary phases are often used for strengthening alloys and thus a compromise, for practical reasons, between single-phase and secondary phases may be chosen. Minor amounts of strengthening phases are generally permissible to improve the strength of the alloy. However, presence of a copper-rich phase, which can form in nickel-base alloys having a copper content high enough to form a separate copper-rich phase, may be impermissible because the phase boundaries between this phase and an austenitic phase may be especially susceptible to metal dusting attack. The presence of the Ni₃Al and/or other secondary phases may also be undesirable because the phase boundaries between this phase and an austenitic phase may be especially susceptible to metal dusting attack.

However, nickel-, chromium-, aluminium-, rare earth element and/or copper-rich secondary phases (e.g. Ni₃Al, NiAl, HfO₂, Al₂O₃, Cr₂O₃ and/or CuO and/or other phases) may be present in order to strengthen the alloy, for example to improve creep resistance at elevated temperatures. Other secondary phases, such as strengthening secondary phases, may also be present.

In one embodiment, the alloy comprises 15-30 wt % chromium, 18-28 wt % chromium, or 20-25 wt % chromium. In one embodiment, the alloy comprises 5-13 wt % copper. Optimal weight percentages of chromium and copper provide a single-phase solid solution alloy that is resistant to carbon corrosion over a range of temperatures. In one embodiment, the alloy comprises 2-8 wt % aluminium, or 3-6 wt % aluminium, for example, around 3% aluminium. Under most conditions, alloying more than 4 wt % of aluminium results in the precipitation of precipitates. These precipitates may be desired or undesired, depending on the intended use of the alloy.

The alloying of copper, chromium and aluminium into nickel produces an alloy with improved carburization, metal dusting and coking resistance, while the inclusion of at least one rare earth element improves the cyclic high temperature oxidation resistance of oxide forming alloys.

According to a second aspect, there is disclosed an article of manufacture including a nickel-base alloy comprising: 12-40 wt % chromium; up to 13 wt % copper; up to 8% aluminium; balance nickel and incidental impurities. The inclusion of a nickel-base alloy in an article of manufacture will impart the characteristics of having improved carbon corrosion resistance and reasonable oxidation resistance.

In one embodiment, the nickel-base alloy may further comprise one or more rare earth elements, up to a combined total of 1 wt %. The rare earth element may be at least one of yttrium, hafnium, cerium, zirconium, scandium or lanthanum. The inclusion of at least one rare earth element improves the alloy's cyclic high temperature oxidation resistance. The combined wt % total of rare earth elements, in embodiments where the alloy includes rare earth elements, may be lower than 1 wt %. For example, the alloy may contain up to 0.5 wt %, 0.1 wt % or 0.01 wt % rare earth element(s).

In one embodiment, the article is in the form of a sheet, tubing, wire, or coating on a substrate.

In one embodiment, the article may be heat-treated. The article may be heat-treated by annealing, tempering, or holding at, for example, 1200° C. for 24 hours. Such processes increase the average grain size, resulting in fewer grain boundaries and therefore fewer precipitation sites and/or fast diffusion paths for carbon. The grain size may be increased to, for example, 100 μm, 500 μm, 1 mm, 5 mm, 40 mm or 100 mm.

The article may be exposed to temperatures of 400-1000° C., and more commonly to temperatures of 600-900° C., and still exhibit carbon corrosion resistance and reasonable high temperature oxidation resistance.

In one form, the article may form part of a chemical processing or conveying apparatus. For example, the article may form at least a part of a device that is adapted for at least one of: steam reforming; syngas production; fertilizer production; ammonia production; or coal gasification. In such processes, devices are regularly exposed to high temperature gases with high carbon potentials.

The article may be formed by metal casting, metal cutting or metal forming techniques.

The article of manufacture disclosed in the second aspect may include or be formed by the nickel-base alloy as otherwise disclosed in the first aspect.

According to a further aspect, the invention may provide a method for producing a nickel-base alloy comprising alloying a first amount of nickel with a second amount of chromium and a third amount of copper so as to produce the nickel-base alloy, wherein the second and third amounts are dependent on each other and are chosen so that the alloy is containing a maximum of second and third amounts while substantially remaining a single-phase alloy.

The method may further comprise alloying nickel with a fourth amount of aluminium so as to produce the nickel-base alloy comprising nickel, copper, chromium and aluminium, wherein the fourth amount is independent from the second and third amounts and wherein the fourth amount corresponds to up to 8 wt % of the nickel-base alloy.

According to a variation, the second and third amounts may be chosen so that the alloy is a single phase alloy and has a composition that corresponds to a phase boundary of the Ni-Cu-Cr system.

According to a variation, the method may further comprise exposing the nickel-base alloy to a gas having a high carbon potential.

### BRIEF DESCRIPTION OF THE DRAWINGS

Notwithstanding any other forms which may fall within the scope of the nickel-base alloy and article of manufacture as defined in the Summary, specific embodiments will now be described, by way of example only, with reference to the accompanying drawings in which:

FIG. 1 shows a Ni-Cu-Cr phase diagram at 1073K;

FIG. 2 shows the comparative weight uptake kinetics of five materials;

FIG. 3 shows images of reacted surfaces of three materials; and

FIG. 4 shows the oxidation kinetics of four materials.

### DETAILED DESCRIPTION OF SPECIFIC EMBODIMENTS

There is disclosed a nickel-base alloy comprising: 12-40 wt % chromium; up to 13 wt % copper; up to 8% aluminium; balance nickel and incidental impurities. According to one particular embodiment, the alloy comprises: 18-28 wt % chromium; 5-13 wt % copper; and 2-6 wt % aluminium. The alloy may also include one or more rare earth elements up to a combined total of 1 wt %. An alloy with this composition has been shown to have an improved carbon corrosion resistance at temperatures of about 400-1000° C. Such an alloy could therefore be utilised in chemical processing or conveying apparatus, such as steam reforming, syngas production, fertilizer production, ammonia production or coal gasification, where gases with high carbon potentials are present.

Both chromium and aluminium form a protective oxide scale on the surface of the alloy when exposed to high temperatures. These scales protect the bulk of the alloy from exposure to carbon in corrosive gases. Copper is introduced to the alloy to suppress the ability of the nickel-base alloy matrix to catalyse carbon release. Copper therefore assists in reducing the deposition of carbon on the alloy. The inclusion of at least one rare earth element improves the alloy's cyclic high temperature oxidation resistance.

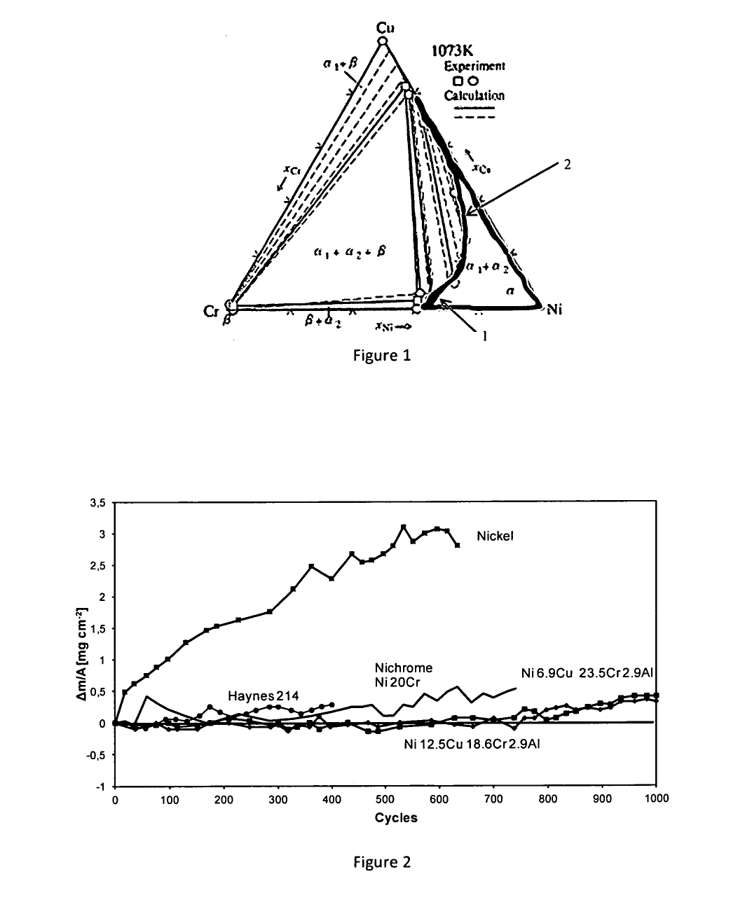

As exemplified in the Ni-Cu-Cr phase diagram shown in FIG. 1, the solubilities of copper and chromium in nickel are dependent on each other. In order to incorporate the maximum copper and chromium levels and maintain a single-phase solid solution alloy, alloy concentrations should be located between points “1” and “2” along the phase boundary. A single-phase alloy is preferred as superior carburisation, metal dusting and coking resistance is provided as there are no phase boundaries in the alloy. Phase boundaries may act as an initiation site for e.g. dusting attack.

### EXAMPLES

Non-limiting examples of nickel-base alloys having a composition according to the present disclosure will now be provided.

Two alloy compositions were chosen to evaluate the influence of the copper to chromium ratio on the carbon corrosion resistance abilities of the nickel-base alloys. The first sample had a high copper content, sacrificing the chromium content to preserve a single-phase matrix. The second sample had a lower copper content, allowing additional chromium alloying. To target the effect of the copper-chromium ratio, the aluminium content remained constant in the samples. Compositions of the two alloys are provided:

TABLE 1
Sample alloy compositions

| Designation | Nickel | Copper | Chromium | Aluminium |
|---|---|---|---|---|
| Ni 12.5Cu | balance | 12.5 | 18.6 | 2.9 |
| Ni 6.9Cu | balance | 6.9 | 23.5 | 2.9 |

To investigate the performance of nickel-base alloys having a composition according to the present disclosure, “Haynes 214” and Ni-20Cr (“Nichrome”) were used as comparative samples. Haynes 214 is a Haynes International trademark and is known to show excellent resistance to carburisation in carburizing environments. Nichrome is known to show good high temperature corrosion resistance in various atmospheres. Haynes 214 has the following composition:

TABLE 2
Composition of Haynes 214 [wt %]

| Ni | Cr | Al | Fe | Mn | Si | Zr | C | B | Y |
|---|---|---|---|---|---|---|---|---|---|
| 75 | 16 | 4.5 | 3 | 0.25 | 0.2 | 0.1 | 0.05 | 0.01 | 0.01 |

A test gas composition was chosen that could be encountered and regarded as a typical gas composition that causes metal dusting corrosion. Such a gas would be encountered during the industrial production of ammonia. Table 3 lists the gas composition, temperature and resulting carbon activity and oxygen partial pressure of the test gas:

TABLE 3
Atmospheric conditions during metal dusting exposure tests

| Temperature | Pressure | CO | H₂ | CO₂ | H₂O | N₂ | P_{O2}/1 atm | a_{c} |
|---|---|---|---|---|---|---|---|---|
| 650° C. | 1 atm | 20% | 20% | 3.20% | 2.60% | Bal | 1.15 × 10⁻²⁴ | 2.3 |
| | | | | | | (54.2%) | | |

The experiments were conducted under cyclic temperature conditions, in which one experimental cycle consisted of one hour exposure at reaction temperature followed by a rapid cool down to ambient temperature which was held for 15 min. This temperature cycling creates strains in oxide scales due to different thermal expansion coefficients and can lead to the spallation of oxide scales, making the metal dusting test much more severe than an exposure at a constant temperature. Generally speaking, the combination of the chosen gas composition and temperature lead to conditions that can be considered as extremely demanding for any material.

### Results and Discussion

FIG. 2 shows the weight uptake kinetics normalised to 1 cm² of surface area. It can be seen that pure nickel has a more or less uniform weight gain until the build up of corrosion product becomes unstable and falls off. This behaviour reflects that nickel offers no protective mechanism to counter metal dusting attack. “Nichrome” shows periods of fast weight gain followed by spallation, indicating at least some protection by chromium oxide. However, at exposure times longer than about 350 cycles, the weight increase becomes clearly visible. “Haynes 214” shows similar weight gain behaviour, on a generally lower level than that of “Nichrome”. Both Ni 12.5Cu and Ni 6.9Cu samples show virtually no weight increase until about 800 cycles.

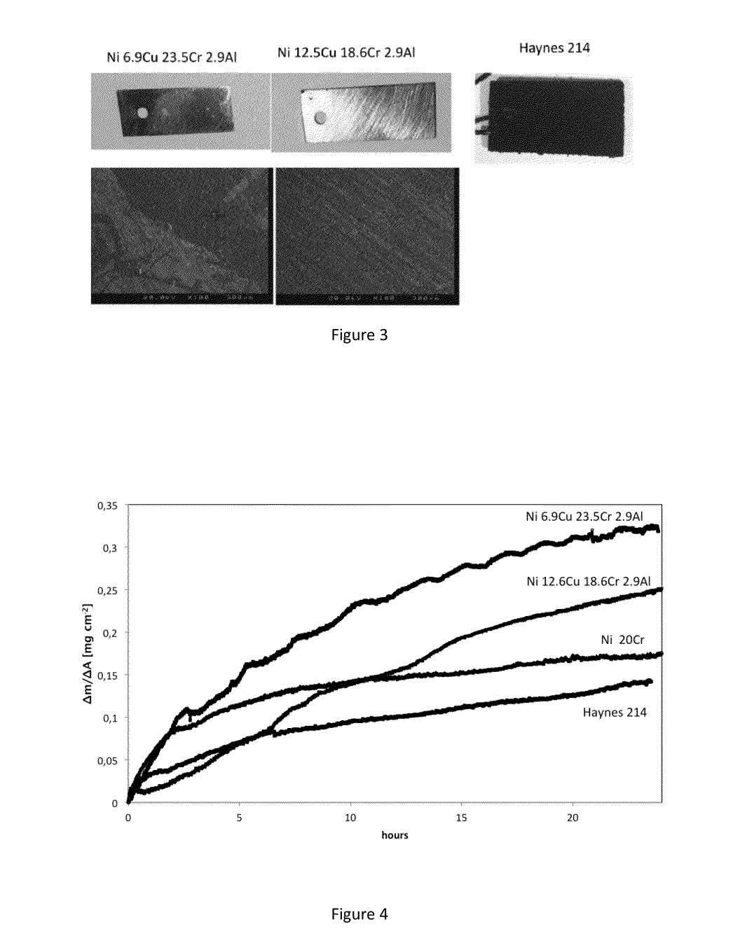

The weight uptake kinetics are also reflected in the surface images, taken after the samples had been exposed for 300 cycles, as shown in FIG. 3. It can be clearly seen that the “Haynes 214” sample is covered by a thick layer of corrosion product, while both Ni 12.5Cu and Ni 6.9Cu samples show no visible carbon deposition.

The oxidation resistance of the alloys was also determined. Oxidation resistance was tested for 24 hours using thermo gravimetric analysis, which allows continuous weight recordings during the experiment. A reaction gas of dry air, at 900° C., was chosen.

FIG. 4 shows the resulting oxidation kinetics, again normalized to a surface area of 1 cm². All investigated alloys showed parabolic oxidation kinetics indicating the growth of protective oxides that retard further oxidation. While the “Haynes 214” and “Nichrome” alloys perform better than the Ni 12.5Cu and Ni 6.9Cu sample alloys, the performance of the sample alloys is still adequate for high temperature applications.

The two alloy compositions chosen are not necessarily the upper and lower levels for chromium and copper content which lead to excellent metal dusting resistance. Depending on the environmental conditions, such as temperature, carbon activity and oxygen partial pressure, chromium to copper ratios other than those shown in Table 1 may also lead to highly carbon corrosion resistant alloys. However, given the dusting performance of “Nichrome”, it is considered that only alloys with copper show metal dusting resistance.

1. A nickel-base alloy comprising: 12-40 wt % chromium; up to 13 wt % copper; up to 8% aluminium; balance nickel and incidental impurities.

2. A nickel-base alloy as claimed in claim 1 further comprising one or more rare earth elements up to a combined total of 1 wt %.

3. A nickel-base alloy as claimed in claim 1 wherein the alloy is a substantially single-phase solid solution alloy.

4. A nickel-base alloy as claimed in claim 1 wherein the alloy preferably comprises 18-28 wt % chromium.

5. A nickel-base alloy as claimed in claim 1 wherein the alloy preferably comprises 5-13 wt % copper.

6. A nickel-base alloy as claimed in claim 1 wherein the alloy preferably comprises 2-6 wt % aluminium.

7. A nickel-base alloy as claimed in claim 6 wherein the alloy more preferably comprises around 3% aluminium.

8. A nickel-base alloy as claimed in claim 1 exposed to a gas having a high carbon potential.

9. An article of manufacture including a nickel-base alloy comprising: 12-40 wt % chromium; up to 13 wt % copper; up to 8% aluminium; balance nickel and incidental impurities.

10. An article of manufacture as claimed in claim 9 wherein the alloy further comprises one or more rare earth elements up to a combined total of 1 wt %;

11. An article of manufacture as claimed in claim 10 wherein the rare earth element is at least one of yttrium, hafnium, cerium, zirconium, scandium or lanthanum.

12. An article of manufacture as claimed in claim 9 wherein the article is in the form of a sheet, tubing, wire or coating on a substrate.

13. An article of manufacture as claimed in claim 9 wherein the article is able to be exposed to temperatures of 400-1000° C.

14. An article of manufacture as claimed in claim 13 wherein the article is more preferably able to be exposed to temperatures of 600-900° C.

15. An article of manufacture as claimed in claim 9 wherein the article forms part of a chemical processing or conveying apparatus.

16. An article of manufacture as claimed in claim 9 wherein the article is at least a part of a device adapted for at least one of: steam reforming; syngas production; fertilizer production; ammonia production; or coal gasification.

17. Method for producing a nickel-base alloy comprising alloying a first amount of nickel with a second amount of chromium and a third amount of copper so as to produce the nickel-base alloy, wherein the second and third amounts are dependent on each other and are chosen so that the alloy is containing a maximum of second and third amounts while substantially remaining a single-phase alloy.

18. Method for producing a nickel-base alloy according to claim 17 further comprising alloying nickel with a fourth amount of aluminium to produce the nickel-base alloy, wherein the fourth amount is independent from the second and third amounts, and wherein the fourth amount corresponds to up to 8 wt % of the nickel-base alloy.

19. Method for producing a nickel-base alloy according to claim 17 wherein the second and third amounts are chosen so that the alloy is a single phase nickel-base alloy and has a composition that corresponds to a phase boundary of the Ni-Cu-Cr system.

20. Method for producing a nickel-base alloy according to claim 17, further comprising exposing the nickel-base alloy to a gas having a high carbon potential.
